(19) United States
(12) Patent Application Publication
(10) Pub. No.: US 2011/0110076 A1
(43) Pub. Date: May 12, 2011

(54) Foil Cushion Arrangement

(76) Inventor: Thomas Langner, Schwanewede (DE)

(21) Appl. No.: 12/741,881

(22) PCT Filed: Nov. 10, 2008
(86) PCT No.: PCT/EP2008/009473

§ 371 Date: Jan. 17, 2011

(30) Foreign Application Priority Data
Nov. 9, 2007 (DE) 20 2007 015 754.1

(51) Int. Cl. F21S 8/00; E04H 15/20

(52) U.S. Cl. 362/145; 52/2.23

(57) ABSTRACT

A foil cushion is described, in particular, a building envelope element with at least one foil cushion that has two outer foil layers that form, between themselves, a cavity that is advantageously closed in an essentially fluid-tight way and that contains a fluid medium, in particular, air. The special feature of the invention consists in that in the cavity there is a carrier on which a group of light-emitting diodes displaying advantageously alphanumeric symbols and/or images is attached on this carrier. Advantageously, the carrier can be arranged as an additional foil layer.

The invention relates to a foil cushion arrangement, in particular, a building envelope element, with at least one foil cushion that has two outer foil layers that form, between themselves, at least one cavity that is closed advantageously in an essentially fluid-tight way and that contains a fluid medium, in particular, air.

Such foil cushion arrangements are known and are used, in particular, for forming foil roof systems and foil façade systems. These foil roof and foil façade systems are used advantageously for erecting commercial structures, such as shopping centers, sports arenas and stadiums, amusement parks, and convention centers, where convention roofing or façade structures are not recommended, whether for structural or economical reasons. In particular, very large roof and façade surfaces can benefit from the advantages associated with foil roof or foil façade systems, such as lightness, thermal insulation, light transparency, and designability of the coloring. Furthermore, foil cushion arrangements could also be used, however, within a building, for example, for building walls or partitioning walls.

Typically, the foil cushions are made from two outer foil layers that are connected to each other in a fluid-tight way, in order to form, between themselves, a cavity that is closed in an essentially fluid-tight way. During the production of the foil cushion, a fluid medium, in particular, a gas, such as, e.g., air, is filled into this cavity, wherein the foil layers are tensioned accordingly and the foil cushion obtains its intended shape. Also, in the installed state, the foil cushions are usually equipped with a device for supplying a fluid medium by means of which, for example, the air pressure in the foil cushion can be regulated. The fluid medium introduced into the foil cushion is used, however, not only for shaping the foil cushion, but also for thermal insulation, which represents an additional advantage of foil systems.

The invention now proposes to arrange a carrier in the cavity, wherein a group of lighting means advantageously displaying alphanumeric characters and/or images is attached to this carrier.

With the help of the invention, the foil cushion arrangement is supplied with an additional function in that it can also be used as a lighting device or display device and, in particular, as a screen for displaying alphanumeric characters and/or images. In particular, with the help of the invention it is conceivable to use the foil cushion arrangement as an image projection screen or together with similar foil cushion arrangements for building a large image projection screen. The invention should open up an additional possibility of use, in addition to the actual purpose of a foil cushion arrangement, namely as a part of a building; in principle, however, it is also conceivable to attach one or more foil cushion arrangements according to the invention to an existing wall, in order to be used in this way as a kind of screen.

With respect to a conventional arrangement made from a building wall and a large image projection screen mounted on this wall, the construction according to the invention leads to a significantly lower weight, which leads, not infrequently, to an invaluable advantage from structural considerations. If the foil layers are made essentially from transparent material, the foil cushion arrangement according to the invention also obtains, in addition to its function as part of a building, such as, for example, a building envelope element, and the additional function as a lighting device or screen, the additional function like a kind of window, in order to lead sunlight into the building.

Preferably, the lighting means should be provided in an arrangement and number such that characters and numbers, advantageously in the form of a ticker, or even stationary and moving images are displayed so that they are recognizable from a certain distance. In particular, the building envelope element according to the invention is suitable for displaying advertising.

In particular, for displaying alphanumeric characters and/or images, the lighting means should be arranged on the carrier in a matrix-like shape, that is, ordered like a matrix.

Preferably, the carrier consists, at least in some sections, from a material allowing dimensional changes, in particular, an elastic material. This construction has the advantage that the carrier can be tensioned, in order to come to lie in a level plane or to obtain a continuously curving shape or for lateral pressurization.

Advantageously, the carrier can be constructed as an essentially flat element and, in particular, as an additional foil layer. This construction allows an especially simple production and arrangement of the carrier; in particular, the foil cushion has additional foil layers.

In the case of one refinement of the construction named above, the carrier divides the cavity into a first chamber that is closed in an essentially fluid-tight way between one outer foil layer and the carrier and into a second chamber that is closed in an essentially fluid-tight way between the other outer foil layer and the carrier. Such an arrangement produces improved thermal insulation. In this way, two functions are combined in the carrier in a clever way, which is advantageous for achieving a low overall weight, namely, for one, holding lighting means and, second, improving the thermal insulation by dividing the cavity into two chambers separated from each other.

Another especially preferred construction distinguishes itself in that the carrier is constructed essentially as a mesh foil that has a plurality of strip-shaped sections that run at an angle, advantageously at approximately a right angle to each other and that cross at node sections, wherein at least one lighting means is attached to at least one part of the node sections. The use of such a mesh foil offers advantages with respect to production, and indeed, especially both with respect to the arrangement and orientation of the lighting means relative to each other and also the arrangement within the foil cushion. In addition, the production of such a mesh foil requires a relatively small amount of material, which has an advantageous effect, in turn, on costs. Finally, a mesh foil is especially transparent to light, so that the inlet of sunlight is obstructed only to a relatively small extent.

One refinement of the construction named above with an intermediate foil layer that is arranged between the two outer foil layers and that divides the cavity into a first chamber that is closed in an essentially fluid-tight way between one outer foil layer and the intermediate foil layer and into a second chamber that is closed in an essentially fluid-tight way between the other outer foil layer and the intermediate foil layer is distinguished in that the mesh foil contacts, at least in some sections, on the intermediate foil layer and is attached to this layer advantageously at least in some sections. If the intermediate foil layer has a curved shape, the mesh foil should be arranged on the side of the intermediate foil layer pointing in the direction of curvature. This construction produces an especially effective and simultaneously simple possibility for holding the mesh foil within the foil cushion.

In the case of another preferred construction, diffuser means are allocated to the lighting means. Such diffuser means can increase the effective cross section of the light beam generated by the lighting means, which leads to an improved optical effect of an image generated by all of the lighting means.

In the case of a first preferred variant of this construction, the diffuser means are provided on a first outer foil layer. Here, the diffuser means can be constructed as flat opaque elements. Preferably, the flat opaque elements should be connected integrally with the first outer foil layer and should thus form their surface-area sections. In this case of this construction, the diffuser means can be realized in an especially simple, by effective way, because they are provided as flat, opaque elements on the first outer foil layer and are constructed advantageously as surface-area sections of the first outer foil layer.

It is also conceivable to unite the individual flat opaque elements into a common flat opaque element covering the lighting means as a whole, in that the individual flat opaque elements allocated to the lighting means form individual sections of the common flat opaque element.

The best effect of the diffuser means provided on the first outer foil layer can be achieved in that the first outer foil layer and the carrier holding the lighting means run approximately parallel to each other. For this purpose, preferably at least one spacer can be used that holds the carrier and the first outer foil layer at a distance from each other. Preferably, this spacer could be formed from a peripheral frame and could consist of, for example, a metal profile. If an intermediate foil layer is provided that divides the cavity into a first and a second chamber, the first outer foil layer and the intermediate foil layer should preferably be attached in a fluid-tight way on the spacer, so that, in this refinement, the spacer bounds the chamber formed between the first outer foil layer and the intermediate foil layer on its peripheral edge in a similarly fluid-tight way.

A second especially preferred variant of the construction in which diffuser means are allocated to the lighting means distinguishes itself in that the diffuser means are constructed as a cap that at least partially surrounds at least one lighting means and that is made from opaque material at least in some sections. In the case of this variant, an outer foil layer is not used for achieving a diffuser effect, but instead remains, in this respect, unused. Instead, in the case of this variant, a body is used as the diffuser means, wherein this body has the shape of a cap or a bowl and at least partially covers the at least one lighting means.

Preferably, the caps are attached on the carrier. For this purpose, the caps could preferably have a flange-like edge that forms an essentially flat contact on the carrier for the attachment of the caps on the carrier. For attaching the caps on the carrier, advantageously the flange-like edge could be bonded on the carrier or also fixed, for example, by means of rivets or screws.

Advantageously, the caps have approximately the shape of a bell. The at least one section of the cap approximately opposite the lighting means should be opaque. The caps could be made advantageously from plastic.

If a lighting means is connected to an electronic circuit, this should be similarly covered at least partially by the cap allocated to the lighting means.

Finally, preferably the lighting means should consist of light-emitting diodes that distinguish themselves, in particular, through their low consumption and their robustness.

Furthermore, according to another aspect of the invention, a lighting means arrangement with a carrier is proposed on which a group of lighting means is attached, wherein this group displays advantageously alphanumeric characters and/or images, characterized in that the carrier is constructed essentially as a mesh foil with a plurality of strip-shaped sections that run at an angle, advantageously at an approximately right angle relative to each other and that cross at node sections, wherein at least one lighting means is attached on at least one part of the node sections. Such a lighting means arrangement can be used preferably in display windows, existing glass walls, or also already existing foil cushion arrangements. In order to be able to tension the carrier for a planar orientation, the carrier should preferably be made at least in some sections from a material that allows dimensional changes, in particular, an elastic material.

Preferred embodiments of the invention will be explained below with reference to the accompanying drawings. Shown are:

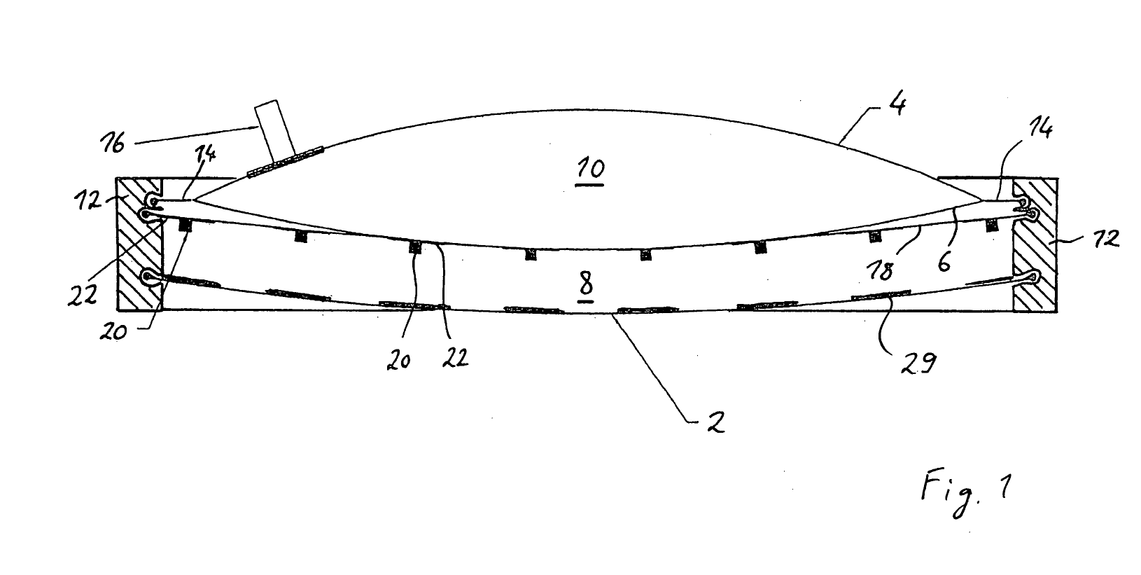

FIG. 1 schematically in cross section, the construction of a foil cushion according to a first preferred construction;

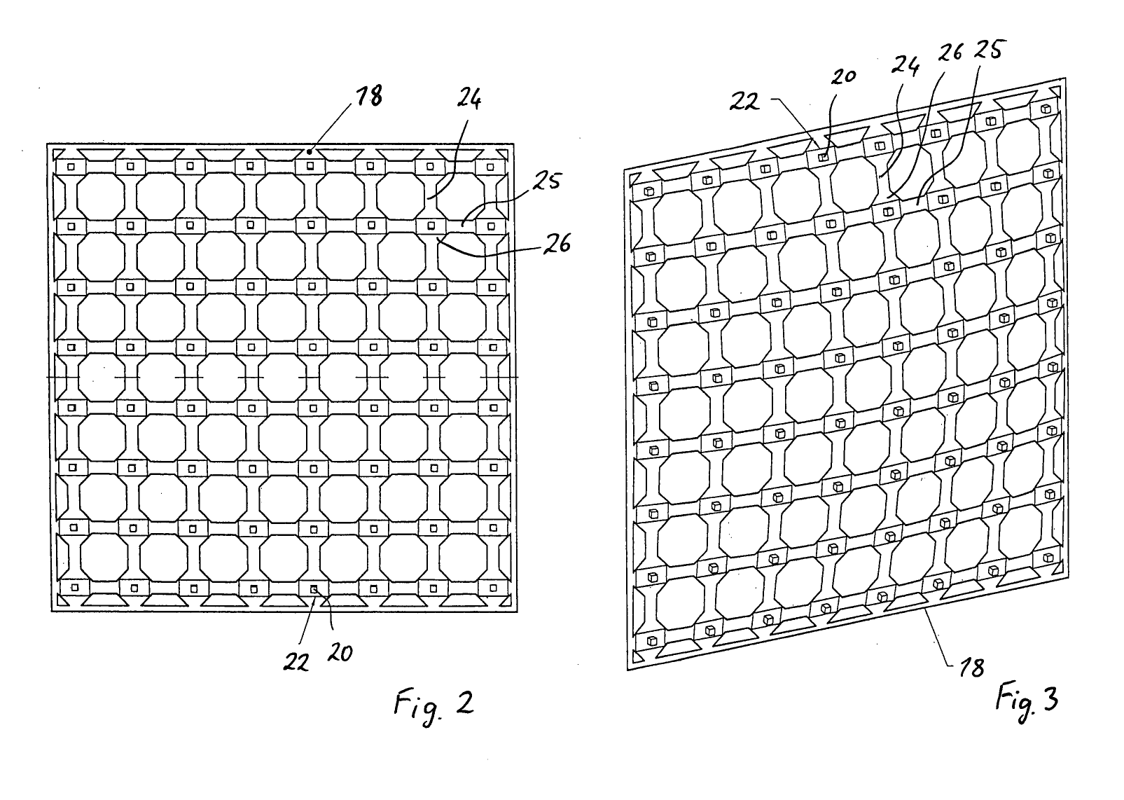

FIG. 2 in a top view, a carrier foil used in the foil cushion of FIG. 1 with light-emitting diodes attached to this foil cushion,

FIG. 3 the carrier foil from FIG. 2 in a perspective view;

FIG. 4 in a top view, an outer foil of the foil cushion from FIG. 1 with diffuser means according to a first preferred variant;

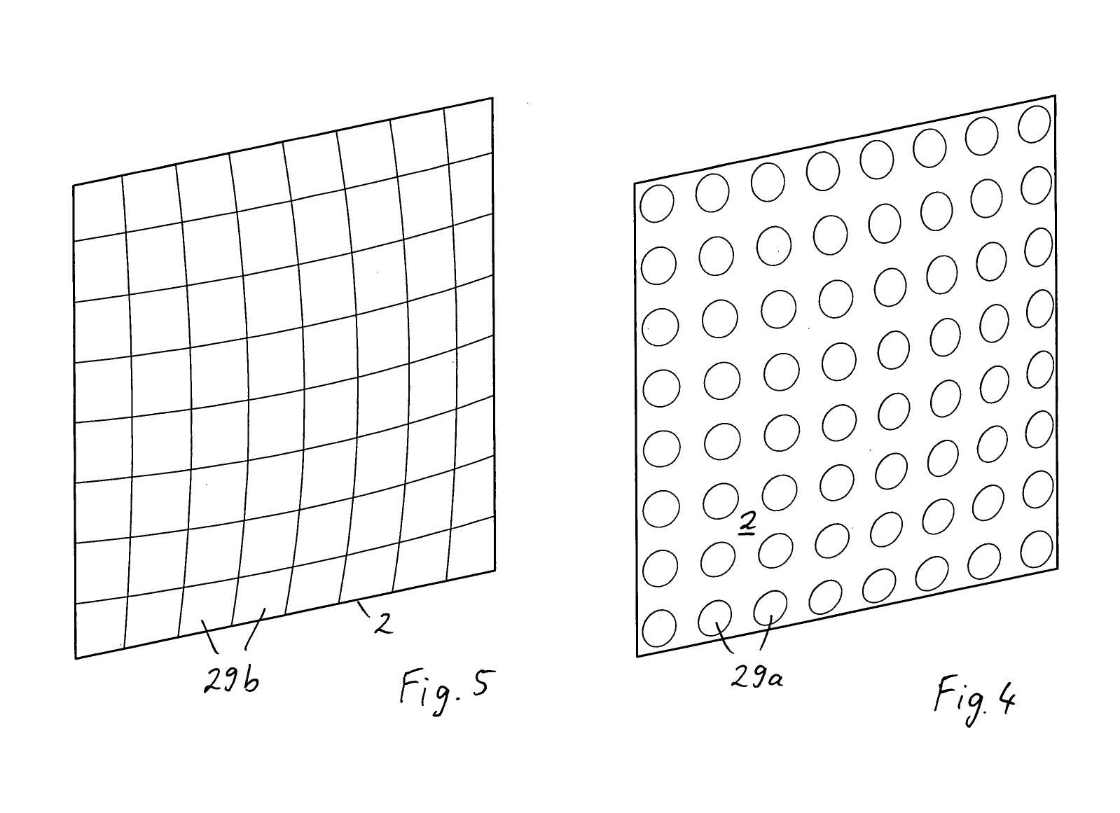

FIG. 5 in a top view, an outer foil of the foil cushion from FIG. 1 with diffuser means according to a second preferred variant;

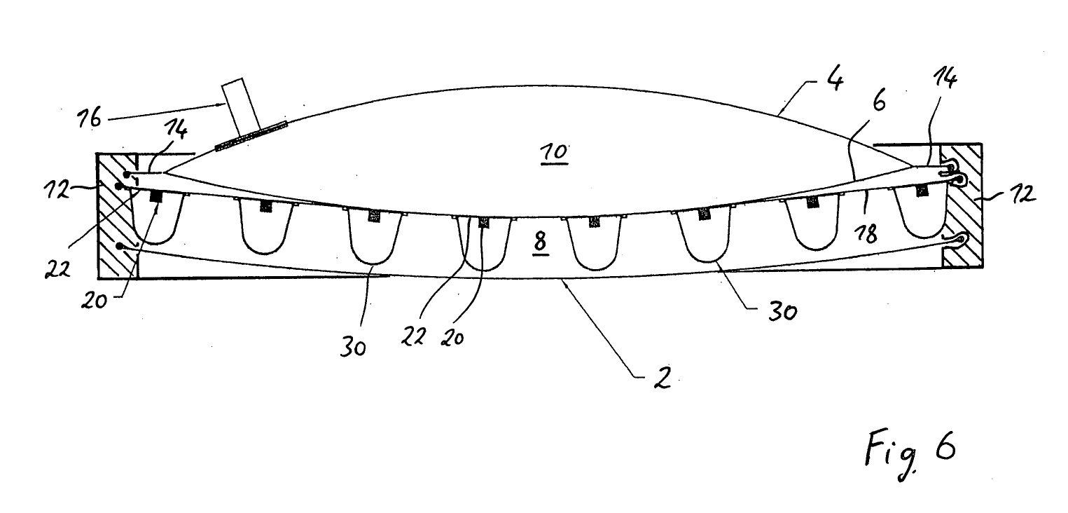

FIG. 6 schematically in cross section, the construction of a foil cushion according to a second preferred construction;

FIG. 7 in a top view, a carrier foil used in the foil cushion from FIG. 6 with diffuser elements attached to this foil cushion;

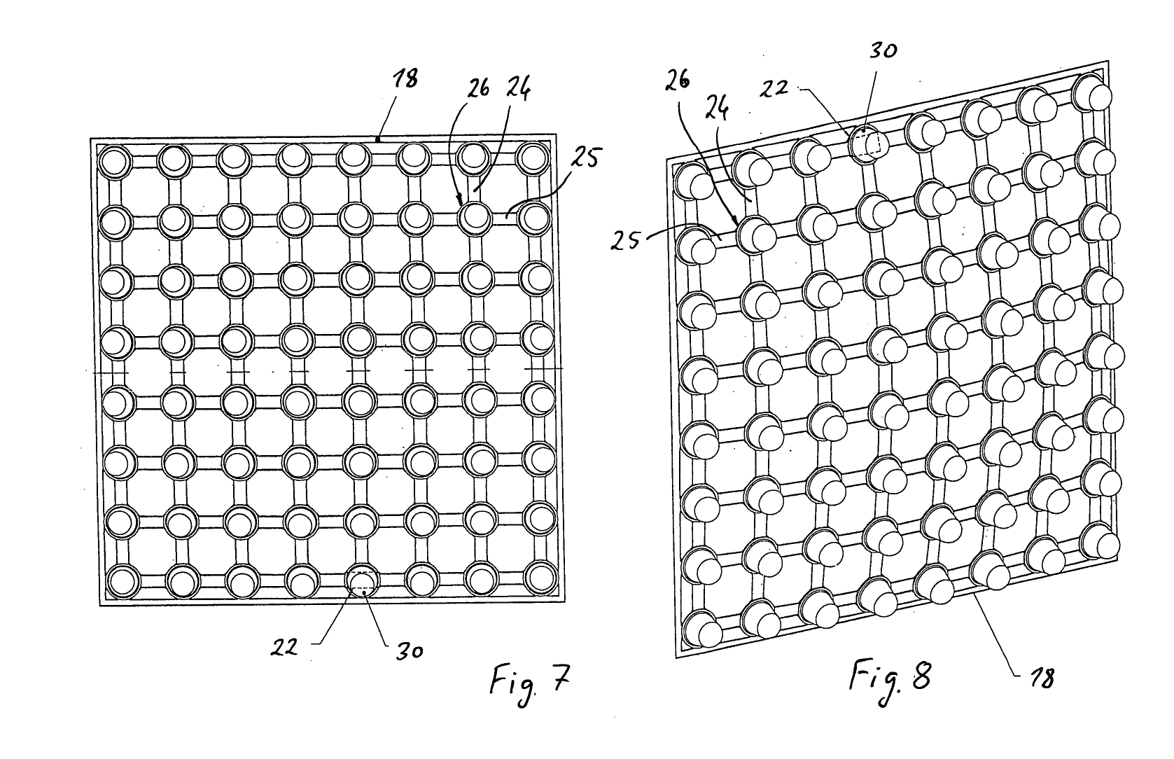

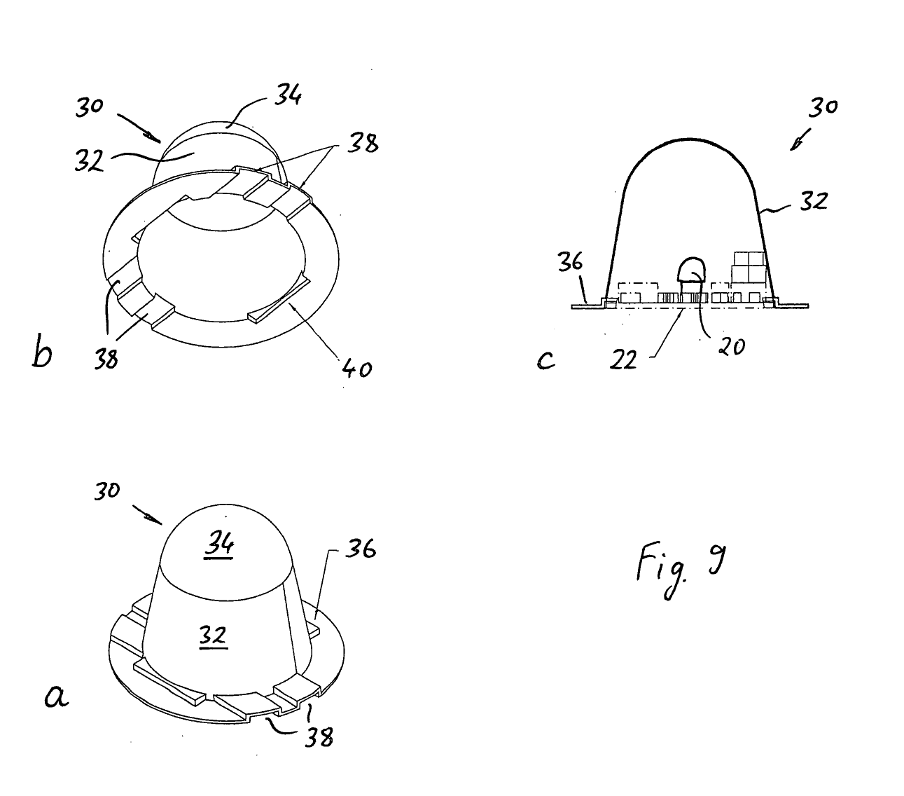

FIG. 8 the carrier foil of FIG. 7 in a perspective diagram; and

FIG. 9 an enlarged individual view of a diffuser element in a perspective view obliquely from above (a), in a perspective view obliquely from below (b), and also in longitudinal section (c).

In FIGS. 1 and 6, two different constructions of a foil cushion are shown that is used preferably as a roof foil cushion or façade foil cushion. For the construction of a foil roofing system or a foil façade system, a plurality of such foil cushions is used, wherein these cushions are interconnected and arranged one next to the other. In this way, the foil cushion shown in FIGS. 1 and 6 usually forms a part of a foil roofing or foil façade system. Alternatively, however, in principle it is also conceivable to provide only a single foil cushion especially for constructing a roof or a façade with a small surface area. Furthermore, however, the mentioned foil cushion could also be used within a building, that is, in particular, for the construction of walls or partitioning walls.

The foil cushion shown in FIG. 1 according to a first preferred construction has a first outer foil 2 and a second outer foil 4. Furthermore, between the two outer foils 2, 4 there is a middle foil 6 that divides the cavity defined by the two outer foils 2, 4 into a first chamber 8 between the first outer foil 2 and the middle foil 6 and a second chamber 10 between the second outer foil 4 and the middle foil 6. The foils 2, 4, 6 are made from elastic material and are slightly expandable.

As can be seen further in FIG. 1, the foil cushion shown there has a peripheral frame 12 that is typically made from a metal profile. All three foils 2, 4, 6 are attached on the frame 12. In the shown embodiment according to FIG. 1, the second outer foil 4 and the middle foil 6 are connected to each other at their edges by a beaded foil 14 that is held on the frame 12. Therefore, in the shown embodiment, the second chamber 10 obtains the form of a cushion that is bounded exclusively by the second outer foil 4 and the middle foil 6 and that is attached with the help of the peripheral beaded foil 14 on the frame 12. The foils are held on the frame 12 conventionally with the help of a beaded cable that is introduced into a groove formed on the inside of the frame 12, as can be seen schematically in FIG. 1.

The first outer foil 2 is held on the frame 12 at a distance to the middle foil 6, as can be seen further in FIG. 1. Thus, the first chamber 8 is bounded not only by the first outer foil 2 and the middle foil 6, but instead also additionally along its edge by the frame 12.

By means of an inlet valve 16, air is blown into the second chamber 10, wherein the second outer foil 4 and the middle foil 6 are tensioned accordingly and the cushion shape that can be seen in FIG. 1 is imparted to the second chamber 10. Then the air inlet valve 16 is closed, so that the chamber 10 forms an essentially gas-tight hollow space in which the air is under pressure.

Likewise, the first chamber 8 is filled with air, wherein the first outer foil 2 curves outward, while the middle foil 6 curved in the direction toward the first outer foil 2 recedes only slightly due to the air pressure prevailing in the second chamber 10 and thus forms a kind of barrier. After blowing the air into the first cavity 8, this is likewise closed, so that the first cavity also forms a cavity that is closed in an essentially gas-tight way and that is bounded, however, not only by the first outer foil 2 and the middle foil 6, but instead also by the peripheral frame 12. Therefore the first outer foil 2 and the middle foil 6 must be attached on the frame 12 in a sealing arrangement.

As can be seen in FIG. 1 in connection with FIGS. 2 and 3, in the foil cushion there is another foil that involves a carrier foil 18 on which light-emitting diodes 20 and circuit boards 22 are attached with an electronic circuit powering or controlling the light-emitting diodes 20. In the shown embodiment, a light-emitting diode 20 sits on a circuit board 22 that is attached, in turn, on the carrier foil 18. Alternatively, however, it is also conceivable to attach, for example, the light-emitting diodes 20 directly on the carrier foil 18 and to arrange the associated electronic circuit next to them.

The carrier foil 18 is arranged in the first chamber 8 adjacent to the side of the middle foil 6 pointing toward the first chamber 8 and thus toward the first outer foil 2 and the light-emitting diodes and circuit boards 22 sit on the side of the carrier foil 18 pointing toward the first outer foil 2.

As can be further seen in FIG. 1, the carrier foil 18 is held on the frame 12 adjacent to the beaded foil 14. The carrier foil 18 is similarly held on the frame 12 usually with the help of a beaded cable that is inserted into a groove constructed on the inside of the frame 12, as can likewise be taken schematically from FIG. 1. This arrangement leads to the result that, after inflating the second chamber 10 with air, the carrier foil 18 is led into contact with the middle foil 6 curved into the first chamber 8 and is curved in the direction of the first outer foil 2. This also has the consequence that the carrier foil 18 that is likewise made from elastic material and therefore is slightly expandable is set under tension and therefore receives the necessary fixing within the foil cushion. Alternatively, however, it is also conceivable, in principle, to stretch the carrier foil 18 into a flat plane.

As can be seen from FIGS. 2 and 3, the carrier foil 18 is constructed as a mesh foil that has a plurality of strip-shaped sections 24, 25 that run at an approximate right angle to each other and that cross at node sections 26. In the shown embodiment, a light-emitting diode 20 sits on each of these node sections 26. Recesses 28 are formed between the strip-shaped sections 24, 25. Through the construction of the recesses 28, not only is material saved in the production of the carrier foil 18, but also the light transparency of the carrier foil 18 is increased, which is especially advantageous when the foil cushion is used as a kind of window, wherein, in this case, preferably all of the foils 2, 4, 6, and 18 should be made from transparent material.

Furthermore, from FIGS. 2 and 3 it can be seen that, in the shown embodiment, the light-emitting diodes 20 are ordered like a matrix and arranged on the carrier foil 18. Such an arrangement is especially suitable for using the light-emitting diodes 20 as a group of pixels for displaying alphanumeric characters and/or fixed or moving images. Thus it is possible to use the foil cushion according to the shown embodiment as an image projection screen or together with similar foil cushions for building a large image projection screen. For this purpose, the light-emitting diodes 20 are controlled by an external control circuit and these diodes are connected by means of electrical lines to the individual circuit boards 22. The electrical control device and also the lines are not shown in the figures. The electrical lines are preferably arranged on the strip-shaped sections 24, 25 of the carrier foil 18 and can be made, for example, from thin wires that are fixed on the strip-shaped sections 24, 25 or molded into these sections or are constructed as conductive sections in the strip-shaped sections 24, 25 of the carrier foil 18.

For improving the optical effect of an image generated by all of the light-emitting diodes 20, so-called diffuser means are provided with whose help the effective cross section of the light beams generated by the light-emitting diodes 20 and thus of the pixels generated by these light beams can be increased.

In the case of the construction according to FIGS. 1 to 3, the diffuser means are provided on the first outer foil 2 in which they form opaque surface sections 29. At those positions where the first outer foil 2 is to act as a diffuser, it consequently has an opaque construction. The opaque surface-area sections acting as diffuser means are allocated to the individual light-emitting diodes 20 and are consequently arranged in the shape of a matrix in the same way as the light-emitting diodes 20, as can be seen schematically in FIG. 1. In FIG. 1, the opaque surface-area sections 29 are shown, for the purpose of better representation, as a kind of additional layer that forms a slightly elevated section relative to (the rest of) the first outer foil 2, although according to the previously explained embodiment, the opaque surface-area sections 29 are components of the first outer foil 2 and are thus integrated into this foil. Alternatively, however, it is also conceivable to use separate opaque layer or foil elements as diffuser means that are attached in the way sketched in FIG. 1 onto the first outer foil 2, advantageously through adhesion or welding. Here, in principle it is not significant whether such separate, opaque layer or foil elements are arranged on the inside or the outside of the outer foil 2, wherein for a protected arrangement the inside of the outer foil 2 is recommended. The same applies incidentally also for the construction of the diffuser means as opaque surface-area sections 29.

The opaque surface-area sections 29, whether as integrated components of the outer foil 2 or in the form of layer or foil elements to be applied separately can have, in principle, an arbitrary shape. In the case of a first preferred variant shown in FIG. 4, the opaque surface-area sections have a circular shape and are characterized with reference symbols “29a”. Thus, in the case of this variant, the first outer foil 2 is provided with a plurality of usually point-shaped, opaque surface-area sections that are ordered like a kind of matrix in the same way as the light-emitting diodes 20. FIG. 5 shows a second preferred variant in which the opaque surface-area sections, here designated with the reference symbols “29b”, have a square or rectangular outline. As another difference relative to the first variant of FIG. 4, in the case of the second variant, the opaque surface-area sections 29 used as diffuser means contact each other, as can be seen in FIG. 5, so that the opaque surface-area sections 29b are united into a common opaque, planar element that is formed by the first outer foil 2.

The construction of the diffuser means as opaque surface-area sections 29 on or in the first outer foil 2 has the advantage that the opaque surface-area sections 29 or 29a, 29b used as diffusers are oriented or run approximately parallel to the carrier foil 18 and thus have approximately the same curvature as the carrier foil 18, as can be seen in FIG. 1. With such an arrangement, namely the best effect of the diffuser means provided on or in the first outer foil 2 as opaque surface-area sections 29 or 29a or 29b can be achieved. Not least of all, for this reason, the first outer foil 2 is held on the frame 12 in the shown embodiment at a distance to the beaded foil 14 and the carrier foil 18.

The foil cushion shown in FIG. 6 according to a second preferred construction differs from the first construction according to FIG. 1 in that the first outer foil 2 is used not as a carrier for planar diffuser means and thus also does not take on a diffuser function, but instead diffuser caps 30 are used as diffuser means that are fixed on the carrier foil 18 in the region of the node sections 26 so that they cover the circuit boards 22 together with the light-emitting diodes 20 arranged there, as can be seen in FIGS. 7 and 8 in connection with FIG. 4.

In FIG. 9, the construction of such a diffuser cap 30 is shown in detail. According to the shown embodiment, the diffuser cap 30 has a housing 32 that is advantageously made from plastic and that has, approximately, the shape of a bell. Thus, in the shown embodiment, the housing 32 is made from a rotationally symmetric hollow body whose cross-sectional surface area or diameter is so large on its side open toward the carrier foil 18 that the diffuser cap 30 can enclose the light-emitting diodes 20 together with their associated circuit boards 22, as can be seen in FIG. 9c. On its side lying opposite the light-emitting diodes 20, the diffuser cap 30 is closed and has a head section 34 that is made from opaque material. This opaque head section 32 generates the desired diffuser effect. Alternatively, however, it is also conceivable, in principle, to produce the entire housing 32 from opaque material.

On its side open toward the carrier foil 18, the diffuser cap 30 has a peripheral, flange-like edge 36 that projects outward in the radial direction and that lies in a plane extending approximately at a right angle to the center axis of the diffuser cap 30. In the shown embodiment, the flange-like edge 36 is used essentially for holding the diffuser cap 30 on the carrier foil 18, in that the flange-like edge 36 forms a planar contact on the carrier foil 18 and is also attached to this foil. The attachment is realized, advantageously, by a positive-fit connection or adhesion.

In order to be able to lead the cables to the circuit boards 22 surrounded by the diffuser cap 30, the flange-like edge 36 is provided with so-called channels 38 that have the shape of bulges directed upward, as can be seen from FIGS. 9a and b. Thus, for the diffuser cap 30 mounted on the carrier foil 18, a feed through is produced between the surface of the carrier foil 18 and the flange-like edge 36, wherein the cables are led through this feed through. Furthermore, as can be seen from FIG. 9b, the flange-like edge 36 is provided on its inside with two opposing recesses 40 that run tangentially and that are used for holding the corresponding, adjacent side edges of the circuit boards 22, in order to be able to better fix the circuit boards 22.

1. Foil cushion arrangement, in particular, building envelope element, with at least one foil cushion that has two outer foil layers that form, between themselves, at least one cavity that is advantageously closed in an essentially fluid-tight way and that contains a fluid medium, in particular, air, including a carrier that is arranged in the cavity, wherein a group of lighting means that display advantageously alphanumeric characters and/or images is attached on this carrier.

2. Foil cushion arrangement according to claim 1, wherein the lighting means are arranged on the carrier in the shape of a matrix.

3. Foil cushion arrangement according to claim 1, wherein the carrier is made from a material allowing dimensional changes, in particular, an elastic material, at least in some sections.

4. Foil cushion arrangement according to claim 1,
wherein the carrier is constructed as an essentially planar element.

5. Foil cushion arrangement according to claim 1,
wherein the carrier is constructed as an additional foil layer.

6. Foil cushion arrangement according to claim 4,
wherein the carrier divides the cavity into a first chamber that is closed in an essentially fluid-tight way between one outer foil layer and the carrier and into a second chamber that is closed in an essentially fluid-tight way between the other outer foil layer and the carrier.

7. Foil cushion arrangement according to claim 5,
wherein the carrier is constructed essentially as a mesh foil that has a plurality of strip-shaped sections that run at an angle, advantageously at approximately a right angle, relative to each other and that cross at node sections, wherein at least one lighting means is attached on at least one part of the node sections.

8. Foil cushion arrangement according to claim 7, with an intermediate foil layer that is arranged between the two outer foil layers and that divides the cavity into a first chamber that is closed in an essentially fluid-tight way between one outer foil layer and the intermediate foil layer and into a second chamber that is closed in an essentially fluid-tight way between the other outer foil layer and the intermediate foil layer,
wherein the mesh foil contacts the intermediate foil layer at least in some sections.

9. Foil cushion arrangement according to claim 8,
wherein the mesh foil is attached to the intermediate foil layer at least in some sections.

10. Foil cushion arrangement according to claim 8, in which the intermediate foil layer has a curved shape,
wherein the mesh foil is arranged on the side of the intermediate foil layer pointing in the direction of curvature.

11. Foil cushion arrangement according to claim 1,
further comprising diffuser means allocated to the lighting means.

12. Foil cushion arrangement according to claim 11,
wherein the diffuser means are provided on a first outer foil layer.

13. Foil cushion arrangement according to claim 12,
wherein the diffuser means are constructed as opaque, planar elements.

14. Foil cushion arrangement according to claim 13,
wherein the opaque planar elements are connected integrally to the first outer foil layer and thus form their surface-area sections.

15. Foil cushion arrangement according to claim 13, wherein the individual opaque planar elements are united into a common opaque planar element covering the lighting means.

16. Foil cushion arrangement according to claim 12,
wherein the first outer foil layer and the carrier run approximately parallel to each other.

17. Foil cushion arrangement according to claim 16, further comprising at least one spacer that holds the carrier and the first outer foil layer at a distance from each other.

18. Foil cushion arrangement according to claim 17,
wherein the spacer is made from a peripheral frame.

19. Foil cushion arrangement according to claim 18,
wherein the first outer foil layer and the intermediate foil layer are attached on the spacer in a fluid-tight way.

20. Foil cushion arrangement according to claim 18, wherein the spacer is made from a metal profile.

21. Foil cushion arrangement according to claim 11, wherein the diffuser means are constructed as a cap that at least partially surrounds at least one lighting means and that is made from opaque material at least in some sections.

22. Foil cushion arrangement according to claim 21, wherein the caps are mounted on the carrier.

23. Foil cushion arrangement according to claim 22,
wherein the caps have a flange-like edge that forms an essentially planar contact on the carrier for the attachment of the caps on the carrier.

24. Foil cushion arrangement according to claim 21,
wherein the caps have approximately the shape of a bell.

25. Foil cushion arrangement according to claim 21,
wherein at least one section of the cap approximately opposite the lighting means is opaque.

26. Foil cushion arrangement according to claim 21, wherein the caps are made from plastic.

27. Foil cushion arrangement according to claim 21, in which a lighting means is connected to an electronic circuit, wherein the electronic circuit is covered at least partially by the cap allocated to the lighting means.

28. Foil cushion arrangement according to claim 1,
wherein the lighting means are made from light-emitting diodes.

29. Lighting means arrangement with a carrier on which a group of lighting means advantageously displaying alphanumeric characters and/or images is attached,
wherein the carrier is constructed essentially as a mesh foil that has a plurality of strip-shaped sections that run at an angle, advantageously, at approximately a right angle, relative to each other and that cross at node sections, wherein at least one lighting means is attached on at least one part of the node sections.

30. Lighting means arrangement according to claim 29, wherein the carrier is made from a material allowing dimensional changes, in particular, an elastic material, at least in some sections.
